(19) United States
(12) Patent Application Publication
(10) Pub. No.: US 2017/0364982 A1
(43) Pub. Date: Dec. 21, 2017

(54) SYSTEMS AND METHODS FOR IMPROVED APPAREL FIT AND APPAREL DISTRIBUTION

(71) Applicant: Alice Cricket Lee, Bronx, NY (US)

(72) Inventor: Alice Cricket Lee, Bronx, NY (US)

(21) Appl. No.: 15/625,699

(22) Filed: Jun. 16, 2017

Related U.S. Application Data
(60) Provisional application No. 62/351,470, filed on Jun. 17, 2016.

(51) Int. Cl. G06Q 30/06

(52) U.S. Cl. CPC G06Q 30/0621

(57) ABSTRACT

The present invention provides systems and methods for providing garments with improved and customized fits to one or more target consumer groups. One method provides the ability for a consumer to purchase apparel specifically fit for that consumer, as provided through entertainment media and media platforms, using the personal communication device of that consumer. Another method provides for distributing specific apparel to a target consumer group located within a particular geographic location in order to better suit the fit and quantity of the general consumer within that region. Additional aspects are also disclosed.

### FIELD

The present invention pertains to the field of apparel fitting and distribution, and in particular to apparel specifically designed and suited for one or more target consumers, and consumer availability of specifically designed and suited apparel.

### BACKGROUND

Consumers continue to face difficulties with finding apparel that will fit them properly. Retailers and apparel companies also continue to have difficulty with designing and distributing apparel that will fit consumers properly. For consumers, fit problems negatively impact their retail shopping experience, level of apparel spending and brand satisfaction. The cost to apparel companies and retailers k tangible as well as intangible: high rates of returned merchandise, lost potential sales, and brand equity erosion. Even for those apparel brand owners who believe they have solved the fit problem for a “target consumer,” there is a high loss in revenue when a consumer leaves with only a single pair of pants because only one out of five pairs fit properly. Returns on women's apparel to retail stores are estimated to be approximately 10-12% of sales. According to a 2002 study, more than 25% of these returns are due to inconsistent or incorrect fit. Store front retailers process nearly $5 billion in returned merchandise each year. Catalog and eCommerce apparel returns range from 33-35% with the largest single reason for return being “poor fit.”

Currently, apparel fit specifications are based on an industry sizing standard established in the 1940's by The American Society for Testing and Materials (ASTM). This standard has never been updated or revised. Thus, it has become obsolete as body sizes and physiognomy of the any target population has evolved over the last half century. Today, for example, ASTM standard specifications can only provide off-the-rack fit for roughly 13% of women aged 35-55. Apparel companies have been forced to apply their own insights to “tweak” fit specifications, and have achieved only a limited amount of success. In addition, companies now apply “vanity sizing” to many apparels, such that larger sized clothing are labeled with smaller sizes. Together, this has resulted in the dilution of size standards which has only increased consumer confusion, while failing to deliver appreciable improvements in fit.

Apparel fit and sizing are top concerns for apparel brands and retailers worldwide. Based on a recent survey, 62% of consumers say they can't find clothes that fit well; 57% say their body shape won't fit into today's standard sizes; 51% say manufacturers don't make clothes for real bodies. Importantly, fit should include size and design preferences for each specific population, because of the preferred differences exhibited by younger people as compared with middle aged or elderly persons and among ethnic groups. As such, unlike current systems, body cathexis (self body image) must be considered along with body measurements in order to develop a satisfactory fit among targeted populations.

Consumers continue to seek apparel that appeals to them. Often consumers will be exposed to apparel through entertainment media sources, such as television, online streaming and movies, through providers such as Neflix™, Hulu™, CraveTV™, and others, or on digital platforms such as Facebook™, YouTube™, Instagram™ and others. When such apparel is observed through these mediums by a consumer, the consumer may undertake a lengthy search to determine where they can buy these garments. Such searching can be time consuming and may ultimately result in the consumer being unable to find the apparel that appealed to them.

Consumers differ not only in their size, ethnicity and age, but also in geographic location. Apparel that is desired within a certain geographic location may be different to the apparel that is desired in another location. Certain locations are more often frequented by a consumer of a particular characteristic in comparison to other consumers. When such a situation exists the consumer may not be able to find the apparel they seek due to increased purchasing of that particular item within that geographic location.

U.S. Pat. No. 7,092,782, which is hereby incorporated by reference, discloses systems and methods for providing garments with improved and customized fits to one or more target consumer groups. However, these systems and methods can be further improved in various ways.

Therefore there is need for an improved and more modern industry standard for designing and producing apparel. Desired areas of improvement include one or more of: better fits for off-the-rack apparel, reductions in product returns, accelerations in sales performance, increases in consumer confidence and loyalty, improved ease of access to the consumer, and geographically-targeted distribution to better suit the consumers within a given region.

This background information is provided to reveal information believed by the applicant to be of possible relevance to the present invention. No admission is necessarily intended, nor should be construed, that any of the preceding information constitutes prior art against the present invention.

### BRIEF SUMMARY

An object of the present invention is to provide systems and methods for improved apparel fit, and apparel distribution. In accordance with an aspect of the present invention, there is provided a method of providing a garment fit to a target consumer group that includes a plurality of pre-selected persons. Initially common body types for the target consumer group are determined. Once this has be achieved, customized body measurement standards for each of the common body types are established. Next, at least two real fit models are selected for each of the common body types and at least one sample garment for each of the common body types in a range of sizes is created using non-linear grading rules. Following this each sample garment is checked on a fit model selected for each of the range of sizes and for each of the common body types. A block for each sample garment for each of the common body types is prepared after applying the non-linear grading rules and after said checking on a fit model. Finally, the block is used to provide a number of garments fit for the target consumer group.

In accordance with another aspect of the present invention, there is provided a system for preparing a custom fit garment. The system utilizes a database holding quantitative and qualitative data, including body point measurements for common body types. The data used within the database is obtained from a target consumer group used to establish customized body measurement standards for each body type, wherein the target consumer group is a plurality of pre-selected persons. At least one piece of fit information entered into the database is obtained from the real fit models using customized body measurements standards. At least one first real fit model is created within the database, for each body type with body measurements that fall within the customized body measurement standards, as determined by at least one piece of fit information obtained from the real fit model. Next a computing system configured to apply one or more non-linear grading rules creates specifications for the at least one sample garments in a range of sizes for each body type of the target consumer group. Finally the computing system is further configured to adjust, based on at least one second fit model for each body type selected from the target consumer group and used to adjust the fit of the sample garment and prepare a number of custom fit garments for each body type of the target consumer group.

In accordance with another aspect of the present invention, there is provided a computing system for analyzing garment fit. The garment fit analysis utilizes a microprocessor, a memory, and a communication interface. These elements are configured to access at least one piece of information within an apparel database. Once this information is accessed, the elements determine at least one conclusion based upon the at least one piece of information within the apparel database, and use the at least one conclusion to provide additional information to a consumer.

### BRIEF DESCRIPTION OF THE FIGURES

Embodiments of the present invention will be better understood in connection with the following Figure, in which:

FIG. 1 illustrates a flowchart of inventive steps in accordance with one aspect of the present invention.

### DETAILED DESCRIPTION

### Definitions

The term “personal communication device” or “PCD” is used to define a device capable of online communication, such as but not limited to a laptop computer, desktop computer, tablet, mobile phone, television, or other communication device as would be understood by someone skilled in the art.

The term “consumer” is used to define an individual, group, group of individuals, corporation, organization, retail store, apparel buyer, personal shopper, apparel designer, tailor, manufacturer, purchaser, or otherwise as would be understood by someone skilled in the art.

Unless defined otherwise, all technical and scientific terms used herein have the same meaning as commonly understood by one of ordinary skill in the art to which this invention belongs.

### System and Method Overview

The present invention provides systems and methods for providing garments with improved and customized fits to one or more target consumer groups. One method provides the ability for a consumer to purchase apparel specifically made to fit that consumer. The general design of an item of apparel may be observed through entertainment media and media platforms. The observation and purchase may be made using the personal communication device of that consumer. Another method provides for distributing specific garments to a target consumer group located within a particular geographic location in order to better suit the fit and quantity of the general consumer within that region.

In general, embodiments of the present invention provides for an apparel standard system with the following features: (a) addresses fit by height, weight, category, ethnicity, and body shape; (b) incorporates current and authoritative scientific and academic data; and (c) incorporates consumer preferences by size, age, ethnicity, and body shape into grade rules. Thus, embodiments of the present invention enables a manufacturer or retailer to design, produce, and provide for consumer apparel with a consistent fit across all body types, ethnicities, and age groups, independent of brand.

Physical differences and design preferences may be pronounced to varying degrees depending on an age group and/or ethnicity, in part, because there are many distinct body shapes and types within an age group. Examples of body types include average, full, straight, hourglass, curvy, and round. Additionally, body types related to height may include tall, and petite. Importantly, apparel that fits one body type will not necessarily fit the same woman of the same size if a different body type.

Another feature of embodiments of the present invention is the use of a “real fit model,” which, as used herein, is a real individual, or digital model of a real individual, with body measurements that fall within the customized measurement standards (with tolerances) for a given new size grouping (e.g., new sizes based on body type, age, ethnicity, etc., as described above). The customized measurement standards are those obtained with the present invention by researching and analyzing apparel-related data. Such data may be obtained from a large database, as well as from one or more of the following, including market research, survey, questionnaire, focus group, interview, and combinations thereof.

In one embodiment, customized measurement standards may be developed through the application of codes based on body configuration measurements. The codes may be based on measurements relating to different parts of the body, such as but not limited to the torso, legs, upper cage, bust size, arms, and subject height. The codes may define at least thirteen configurations of body code determination, providing a much larger sizing scale than is currently available within traditional apparel industry fit. These codes may also remain applicable to a subject, regardless of changes in the weight of the subject over time.

In another embodiment, customized measurement standards developed through the application of codes based on body configuration measurements, may be applied to a real fit model. The customized measurement standards may also be developed though the application of codes based on body configuration measurements of a real fit model. Such body configuration measurements may be informed over time, to further develop and alter the customized measurement standards. These measurements may be applied to an individual consumer to inform and help create their own personal “real fit profile”.

As such, embodiments of the present invention are not intended to replace clothing design, but, in part, to provide a real body (i.e., real fit model) that fits inside a specific design. All preferences provided by the present invention may be used to inform a design, if a designer chooses to use them. The present invention is also intended for fit technicians, production departments, consumers and apparel companies.

In one embodiment, data obtained from the real fit model implementation and other large apparel-related databases, such as the Textile Technology Corporation's Size USA (Size USA) national data, can be combined and collected within an “apparel database”. This apparel database can be analyzed and used to perform a number of useful functions such as but not limited to the profiling of consumers, real fit model optimization, creating real fit profiles, group commonalities, geographic tendencies, analytics, determining fashion trends and trending fashion personalities, and other functions as would be understood by someone skilled in the art. The process of gaining access to the apparel database, including login procedures, associated cost, and otherwise as would be understood by someone skilled in the art, may be determined by the apparel database provider. The information available to the consumer within the apparel database may be controlled and limited, at the apparel database provider's discretion.

In one embodiment, the apparel database may include a communication mechanism to allow for transfer of signal between various entities. This communication mechanism may allow direct or indirect interaction between entities such as, but not limited to, consumers, apparel database providers, apparel database users, retail stores, digital platform content providers, entertainment media source providers or otherwise as would be understood by someone skilled in the art. Communication between any number of these entities may result in a variety of actions related to the access, distribution, availability, purchase, and provision of apparel.

In another embodiment, it is contemplated that the apparel database may be comprised of more than one database functioning together, or separately. Each individual database that makes up the apparel database may contain different information than other databases, contain the same information as other databases, have different functionality than other databases, have the same functionality as other databases, be available to different consumers or users, be available to the same consumers or users, be connected to other databases, be separate from other databases, or otherwise as would be understood by someone skilled in the art. The specifics and functionality of any database within the apparel database, may be determined by the apparel database provider at their own discretion.

In another embodiment, at least one personal fit identify (also referred to as a “PFI”) may be created for a specific consumer, partner, user, or location. This personal fit identity may contain information related to real fit models, real fit profile, apparel sizing, personal preferences, such as but not limited to color, style, type, material, cost, or other information as would be understood by someone skilled in the art. This PFI may be continually provided to and altered by the apparel database, as further information is collected and included within the apparel database.

In one embodiment, a consumer may access the apparel database through a user interface accessible by a communication network. The consumer may search the apparel database and locate apparel that is suited to that consumer's PFI, which corresponds to their real fit profile. They may set up a user profile to store database preferences or other information as would be understood by someone skilled in the art. The apparel database may provide the user the ability to search, select and purchase apparel—they are able to shop by their shape. This process may be undertaken through the use of a PCD able to access the apparel database through a communication network, during a convenient time and location as determined by the consumer. Once purchased, apparel may be delivered directly to the consumer using an internal delivery process, or a third party delivery service as determined by the apparel database provider, or consumer.

In another embodiment, a consumer may identify with a specific group displaying certain PFI characteristics. They may associate themselves or their user profile with that group in order to gain access to apparel specifically suited for that group's PFI. The consumer may then undertake an apparel database search and/or purchase process as described herein.

In another embodiment, a consumer may decide to follow another consumer or other apparel database user, for the purposes of receiving notifications or communications, about the apparel preferences of that followed consumer or user. The consumer may then undertake an apparel database search and/or purchase process as described herein, and influenced by the preferences of a followed consumer or user.

In another embodiment, it is contemplated that a user of the services being offered by the apparel database provider may access the apparel database for the purposes of providing their own apparel to the apparel database. This apparel may be associated with a PFI in order to better target the market in which that consumer is attempting to provide their own apparel. The process for an apparel database user to provide their own apparel to the apparel database may be controlled and limited by the apparel database provider, at the provider's own discretion.

In another embodiment, a consumer may access the apparel database for purposes of accessing a PFI associated with a particular geographic location. The mix and commonalities of body shapes within a particular location may vary. The PFI may contain information related to the specific real fit profile most commonly associated with that location. The variations and commonalities of the location can be identified and determined by the apparel database. In this way a consumer who is looking to provide apparel to a third party may optimize their apparel purchases to better suit a regional clientele. The apparel database may act as an inventory management system—there is more efficient store planning by geolocation, and a consumer such as a retail store, can make better inventory management decisions. A consumer may then undertake an apparel database search and/or purchase process as described above, improving their overall shopping experience.

In one embodiment, apparel that utilizes a specific real fit profile can be distributed to consumers that correspond to that particular real fit profile through a PFI. Consumers may be exposed to apparel particularly suited to their own PFI, as directed through targeted advertising, television, entertainment media, social media, digital platforms, print media, public relations campaigns, and other avenues as would be understood by someone skilled in the art.

In another embodiment, digital platform content providers such as Facebook™, YouTube™, Instagram™ and others could associate the content available on their platform to one of their users, with an apparel database user profile and/or a PFI associated with that same user. An apparel database user may choose to associate their own apparel database profile and PFI to at least one content provider. Apparel content that becomes available through that content provider may be directed towards characteristics associated with the user's particular PFI (such as real fit profile, geographic location information or otherwise as would be understood by someone skilled in the art). In this way apparel content can be more specifically directed by the content provider to a particular user.

In another embodiment, an entertainment media source such as television, online streaming, movies, or otherwise as provided by an entertainment media source provider such as Netflix™, Hulu™, CraveTV™, and others as would be understood by someone skilled in the art, may associate the entertainment media available to one of their users, with a PFI associated with that user. An apparel database user may choose to associate their own apparel database profile and PFI to at least one entertainment media source or entertainment media source provider. Apparel content that becomes available through that media source may be directed towards characteristics associated with the user's particular PFI (such as real fit profile, geographic location information or otherwise as would be understood by someone skilled in the art). In this way apparel content can be more specifically directed by the entertainment media source provider to a particular user.

In another embodiment, it is contemplated that a content provider, entertainment media source provider, or otherwise as would be understood by someone skilled in the art, may allow a user to access the apparel database through user-imposed interaction with their content or media. Such user-imposed interaction may include but is not limited to the press of a button, selection of a specific option, confirmatory indication of some sort, or otherwise as would be understood by someone skilled in the art. In this way the content provider or entertainment media source provider may allow a user to enter and engage with the apparel database.

The invention will now be described with reference to specific examples. It will be understood that the following examples are intended to describe embodiments of the invention and are not intended to limit the invention in any way.

### EXAMPLES

In one example a local retail store apparel buyer may access the apparel database. The buyer may pay a fee to the apparel database provider to access geographic location data, and may also provide information related to that retail store clientele to the apparel database. The buyer may access the PFI associated with the geographic location in which the retail store is located. The buyer notices that the real fit profile associated with the PFI of the majority of apparel buyers within that location is of a smaller characteristic. The buyer then decides to alter the apparel available within retail store to suit the PFI she has observed. As a consequence of this decision, better suited and more abundant apparel is available to the clientele who visit the buyer's retail store at that particular location.

In another example a national retail store apparel buyer may access the apparel database. The national buyer may pay a fee to the apparel database provider to access geographic location data, and may also provide information related to that retail store's national clientele to the apparel database. The national buyer may access the PFI associated with the geographic locations in which the retail store currently has physical store-front locations. The national buyer notices that the real fit profile associated with the PFI of the majority of apparel buyers within one location in the northern part of the country is of a smaller characteristic, while the real fit profile associated with the PFI of the majority of apparel buyers within one location in the southern part of the country is of a larger characteristic. The national buyer then decides to alter the apparel distribution to the retail store in the northern part of the country to include extra apparel to suit the common PFI she has observed, while reducing the amount of apparel to be distributed to the store that exhibits a PFI of larger characteristic. She then redirects the apparel that was to be distributed to the retail store in the north, to the retail store in the southern part of the country. As a consequence of this decision, better suited and more abundant apparel is available to the clientele who visit the both national buyer's retail stores in the northern and southern locations.

In one example, a consumer “A” decides to watch a television show streamed on Netflix™. As he is watching, he notices that one of the characters in the show is wearing a shirt that he particularly likes. While watching the show on his PCD, he selects the character by tapping his finger upon the screen. When this action is performed, the show is paused and “A” is automatically redirected to the apparel database. The show may be presented along with time-varying data which correlates with the location of purchasable clothing items on the screen, along with instructions to redirect the user to the appropriate location of the apparel database (presented in website form) upon selecting one of the purchasable clothing items. Alternatively, image recognition software may be used to segment the video image, recognize clothing items, and perform an image search of recognized clothing items in the apparel database. At this point “A” is able to log into the database (if he already has created a PFI or profile), browse the database without logging on, or may at that time set up a new profile and/or PFI. Once the apparel database is engaged, the database automatically provides access to the shirt “A” noticed up on the character in the show. The shirt may be suited to the PFI of “A” and may be purchased through the apparel database. The apparel database may keep track of this particular engagement with “A” in order to develop a listing of suggested apparel items similar to the shirt he has just purchased. The apparel database may keep track of other preferences associated with the engagement, such as but not limited to the particular show that “A” was viewing, the entertainment media source that “A” was using, and the number of times that “A” has viewed apparel associated with the character in the show.

In another example, considering the example of “A” as described above, an entertainment media source provider “B”, may engage with the apparel database. “B” may pay a fee to the apparel database provider in order to gain access to PFIs of its users, geographic PFIs of its users, and other information provided by the apparel database as would be understood by someone skilled in the art. “B” may then alter the availability of content on its entertainment media source to better suit the particular PFI of “A” based on “A”s previous apparel database engagements, the geographic location from with “A” is viewing the entertainment media source, or some other factor as provided by the apparel database as would be understood by someone skilled in the art.

In another example, considering the example of “A” and “B” as described above, a digital platform content provider “C” may engage with the apparel database. “C” may access and utilize the information and PFIs available within the apparel database in a similar way to that of “B”. “C” may then provide particular ads to “A” upon “C”s digital platform to better suit the particular PFI of “A” based on “A”s previous apparel database engagements, the geographic location from with “A” is accessing the digital platform, or some other factor as provided by the apparel database as would be understood by someone skilled in the art.

In one example, a consumer “D” decides to enter a shopping center for the purposes of purchasing a new dress. “D” has previously engaged with the apparel database and has set up multiple PFIs. “D” has also provided that her profile and/or PFIs may be accessed through her PCD by certain retail stores; she then provides further information to the apparel database that she is looking for a new dress. As she enters the shopping center, several retail stores are able to access her PFI and send information to “D” related to dresses that suit her profile preferences and/or PFIs, and which are currently available at those particular retail stores. “D”s PCD may send an alert to “D” as she passes a retail store that has provided information to her related to available dresses. When she receives an alert, “D” may be able to send a communication to the retail store that reserves the dress, and prevents another consumer from buying the dress prior to “D” getting a chance to try the dress on in-store. In this way “D” is able to expedite her shopping process, and is able to ensure that she does not miss out on dress that she is particularly interested in.

In one example, an apparel manufacturer consumer decides to utilize the apparel database. In order to access specialized apparel fitting technology, such as real fit models and real fit profiles, the apparel manufacture and apparel database provider enter into a license agreement. The license agreement provides additional access to apparel fitting technology that would not otherwise be available to an individual consumer, in return for a higher access fee. Such additional access may be, but is not limited to a second database, that makes up a part of the overall apparel database, but is not accessible to non-manufacturing consumers. Using the additional apparel fitting technology available to the apparel manufacturer, the apparel manufacturer alters their clothing design to incorporate additional apparel fitting information. Once these new designs are completed, clothing incorporating the additional apparel fitting information is manufactured and sold to customers. These customers express extra satisfaction in fit of the apparel incorporating additional apparel fitting information. The apparel manufacturer consumer decides to renew their license to the apparel database annually in order to have continued access to the specialized apparel fitting technology within.

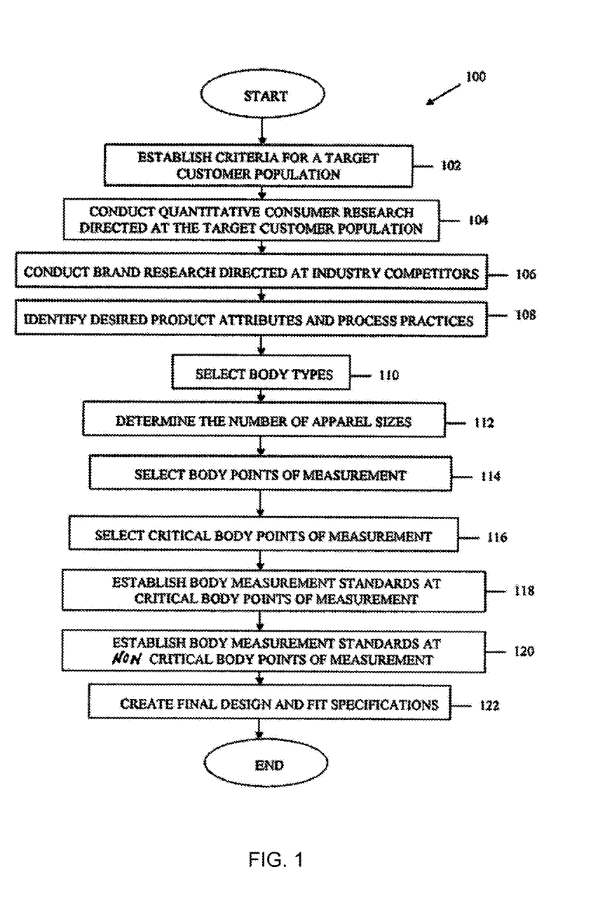

In another example as illustrated in FIG. 1, 102 describes the step of establishing criteria for a target consumer population. The target consumer population may be any group of consumers, especially those not satisfied with the fit and design of apparel currently being offered, such as “Baby Boomer” women within the age range of 35 to 55. At step 104, quantitative consumer research directed at the target consumer group is conducted and may be stored in the apparel database. Optionally, brand research directed at industry competitors may be conducted and stored in the apparel database, as shown at step 106. Proceeding to step 108, desired product attributes and process practices for a design of apparel are identified by the target consumer group. Such product attributes and process practices may be stored within the apparel database as preferences, and associated with a PFI of that particular consumer population. Continuing to step 110, at least two predominant body types that exist in the target consumer group are identified, this identification may be achieved through a search of the apparel database. A body type is typically the general shape of an individual. Moving to step 112, a number of apparel sizes to offer to the target consumer group is selected. This is generally determined after assessing the range of body sizes for the target group. At step 114, body points of measurement, which may be obtained from the apparel database, are selected and used in creating the apparel (garment). Body points of measurement may include all or less than all of the body points of measurement commonly used in the apparel industry. In addition, new body points of measurement may be added as determined from reviewing and analyzing the quantitative data provided by the target group, and as found within the apparel database. At step 116, critical body points of measurement, which may be obtained from the apparel database, are determined from reviewing and analyzing step 108. Such a review and analysis may be accomplished within the apparel database. At step 118, customized body measurement standards are established, these may be critical and noncritical or new body points of measurement as identified for each target and body type. The customized body measurement standards may also be obtained through an analysis of the apparel database. Alternatively, the customized body measurement standards may be stored within the apparel database for subsequent reference or use. Steps for establishing customized body measurement standards may be automated within the apparel database. At step 120, customized body measurement standards at non-critical body points of measurement are established. Steps for establishing body measurement standards at non-critical body points of measurement may be contained within the apparel database and automated. Finally, at step 122, final fit specifications (e.g., fit and design) for each garment, body type and size are determined. Once this determination is made, the results may be stored within the apparel database for subsequent reference and use. Alternatively, the final fit specifications may be determined by the apparel database. It contemplated that the steps as outlined in the system 100 may be completed and enacted through the apparel database at the request of a consumer.

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure some or all of its components in accordance with the system of the invention.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, PL/1, or the like. In addition, each step, or a file or object or the like implementing each said step, may be executed by special purpose hardware or a circuit module designed for that purpose.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

The scope of the claims should not be limited by the preferred embodiments set forth in the examples, but should be given the broadest interpretation consistent with the description as a whole.

We claim:

1. A method of providing a garment fit to a target consumer group that includes a plurality of pre-selected persons, the method comprising:
determining common body types for the target consumer group;
establishing customized body measurement standards for each of the common body types;
selecting at least two real fit models for each of the common body types;
creating at least one sample garment for each of the common body types in a range of sizes using non-linear grading rules;
checking each sample garment on a fit model selected for each of the range of sizes and for each of the common body types;
preparing a block for each sample garment for each body type after applying the non-linear grading rules and after said checking on a fit model; and
using the block to provide a number of garments fit for the target consumer group.

2. A system for preparing a custom fit garment comprising:
a database holding quantitative and qualitative data, including body point measurements for common body types, the data obtained from a target consumer group used to establish customized body measurement standards for each body type, wherein the target consumer group is a plurality of pre-selected persons;
at least one piece of fit information within the database, obtained from the real fit models using customized body measurements standards;
at least one first real fit model within the database, for each body type with body measurements that fall within the customized body measurement standards, as determined by at least one piece of fit information obtained from the real fit model;
a computing system configured to apply one or more non-linear grading rules to create specifications for the at least one sample garment in a range of sizes for each body type of the target consumer group; and
the computing system further configured to adjust, based on at least one second fit model for each body type selected from the target consumer group and used to adjust the fit of the sample garment and prepare a number of custom fit garments for each body type of the target consumer group.

3. The system of claim 2, wherein information related to fit technology, garment fit, geographic location, consumers, users, preferences, and trends may be stored, accessed, analyzed, distributed or otherwise as would be understood by someone skilled in the art, within an apparel database.

4. The system of claim 3, wherein the apparel database may provide a number of services to a consumer, such as but not limited to apparel availability, purchase, access, notifications, analytics, communication mechanisms, profile, and personal fit identify.

5. The system of claim 3, wherein the apparel database may be continually informed and altered as information related to technology, garment fit, geographic location, consumers, users, preferences, and trends are provided to the apparel database.

6. The system of claim 4, wherein a consumer may access the apparel database using a personal communication device.

7. The system of claim 4, wherein a consumer, digital platform content provider, entertainment media source provider, or otherwise as would be understood by someone skilled in the art, may use the apparel database information or services in the provision of its own service.

8. A computing system for analyzing garment fit, the computing system comprising a microprocessor, a memory, and a communication interface and configured to:
access at least one piece of information within an apparel database;
determine at least one conclusion based upon the at least one piece of information within the apparel database; and
use the at least one conclusion to provide additional information to a consumer.

9. The system of claim 8, wherein the at least one conclusion is related to at least one piece of information relating to geographic location, and at least one piece of information relating to garment fit within that same geographic location.
